(19) United States
(12) Patent Application Publication
(10) Pub. No.: US 2006/0266467 A1
(43) Pub. Date: Nov. 30, 2006

(54) Method of forming an absorbent core

(75) Inventor: Joseph Andrew Mlinar, Appleton, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 11/139,703

(22) Filed: May 27, 2005

(51) Int. Cl. B32B 37/00; B32B 38/04; B32B 37/22

(52) U.S. Cl. 156/252; 156/265; 156/269; 156/267

(57) ABSTRACT

A method is disclosed for forming an absorbent core. The method includes depositing a mixture of superabsorbent and fiberized pulp onto a carrier sheet and then wrapping the carrier sheet around the mixture to form an absorbent strip. The absorbent strip is cut into a plurality of absorbent members. Surge members are intermittently secured to a continuous bodyside liner and both are then attached to a bottom surface of the absorbent members. Elastic members are aligned on the continuous bodyside liner adjacent to each of the absorbent members. A continuous outer cover is secured over the elastic members and to a top surface of each of the absorbent members while being joined to the continuous bodyside liner to form an absorbent core web. The absorbent core web is then severed to form individual absorbent cores.

### BACKGROUND OF THE INVENTION

Absorbent cores can be used in many different kinds of products, such as an infant diaper, a feminine pad, a sanitary napkin, a pantyliner, a child's training pant, a menstrual pant, an adult incontinent garment, an incontinent brief, etc. Many such products are disposable and are used to absorb human exudate. A disposable absorbent undergarment is similar in appearance, size and shape to a regular, male or female, cloth underwear except that it can absorb bodily fluids, such as urine, semi-solid and solid excrement. A disposable absorbent undergarment is not designed to be laundered and reused more than once. A disposable absorbent undergarment is intended to be worn by people of all ages including: infants, toddlers, children, adults and senior citizens for single or temporary use. A disposable absorbent undergarment is designed to be pulled up around the user's torso without having to first open the undergarment in order to place it on a person's body. The stretchability of the material from which it is constructed permits the undergarment to snugly conform to the anatomy of the user's torso. A disposable absorbent undergarment can be manufactured in a one piece, unitary configuration having a waist opening and a pair of leg openings. The disposable absorbent undergarment can also be constructed with a two- or three-piece configuration. In the three-piece configuration, the absorbent core can serve as the entire crotch region and thereby decrease the amount of material needed to form the exterior surface of the product.

It has been found that when an absorbent core fits relatively close to the wearer's body, that fluid leakage can be reduced. When the absorbent core conforms to the crotch region of the wearer and when it includes elastically activated side fringes or flaps, it can greatly decrease the likelihood of fluid leakage. Fluid leakage can be perceived as failure of the absorbent core to perform its intended function.

Today, some disposable absorbent undergarments can be broken apart or separated after they have filled with body fluids to ease removal from the person's torso. Other disposable absorbent undergarments are designed to be removed by sliding the undergarment downward off the hips, thighs and legs in a similar fashion as regular cloth underwear. Many disposable absorbent undergarments are sleek in appearance and there outline can not be detected under regular outer clothing like pants, skirts, dresses, etc.

One method of constructing such disposable absorbent undergarments is to secure an absorbent core transversely across front and back panels to form a three-piece structure. The side edges of the front and back panels are then seamed together using an ultrasonic bonder to form a unitary product having a waist opening and a pair of leg openings. In this three-piece design, the absorbent core actually serves the function of an exterior layer of the crotch portion of the disposable absorbent undergarment. This three-piece design tends to be more cost effective to manufacture since it uses less material.

Now a method for forming an absorbent core has been invented that allows the absorbent core to better fit the crotch region of the wearer.

### SUMMARY OF THE INVENTION

Briefly, this invention relates to a method of forming an absorbent core. The method includes the steps of depositing a mixture of superabsorbent and fiberized pulp onto a carrier sheet. The carrier sheet is then wrapped around at least a portion of the mixture to form an absorbent strip. The absorbent strip is longitudinally trimmed into a preconceived shape before it is cut into a plurality of absorbent members. Each absorbent member has an upper and a lower surface. The absorbent members are separated from one another. Surge members are intermittently secured to a continuous bodyside liner, and the surge members and the continuous bodyside liner are attached to the lower surface of each of the absorbent members. Each surge member is vertically aligned under an absorbent member. Elastic members are aligned on the continuous bodyside liner adjacent to each of the absorbent members. A continuous outer cover is secured over the elastic members and to a top surface of each of the absorbent members while being joined to the continuous bodyside liner to form an absorbent core web. The absorbent core web is then trimmed and perforation lines are formed transversely across the absorbent core web at spaced apart intervals. The perforation lines are then broken to form individual absorbent cores.

### BRIEF DESCRIPTION OF THE DRAWINGS

FIG. 1 is a schematic diagram of the apparatus used in the method of forming an absorbent core.

FIG. 2 is a top view of the material flow through a portion of the method, depicted in FIG. 1, starting from the carrier sheet to the point where the absorbent strip is trimmed.

FIG. 3 is a top view of the material flow through a portion of the method, depicted in FIG. 1, starting from the trimmed absorbent strip and proceeding to forming a plurality of individual absorbent members.

FIG. 4 is a top view of the material flow through a portion of the method, depicted in FIG. 1, showing the attachment of a surge member to a continuous bodyside liner.

FIG. 5 is a top view of the material flow through a portion of the method, depicted in FIG. 1, showing the application of adhesive to the outer cover.

FIG. 6 is a bottom view of the material flow through the remaining portion of the method, depicted in FIG. 1, showing the application of elastics, the attachment of the outer cover to the bodyside liner and the trimming of excess material so as to form individual absorbent cores.

FIG. 7 is a top view of two connected absorbent cores showing an adhesive pattern which will be used to secure each absorbent core to two spaced apart webs.

FIG. 8 is a top view showing the individual absorbent cores being secured across two spaced apart moving webs and then cutting the two webs at predetermined locations to form a three-piece disposable absorbent undergarment.

FIG. 9 is a perspective view of a unitary undergarment.

### DETAILED DESCRIPTION

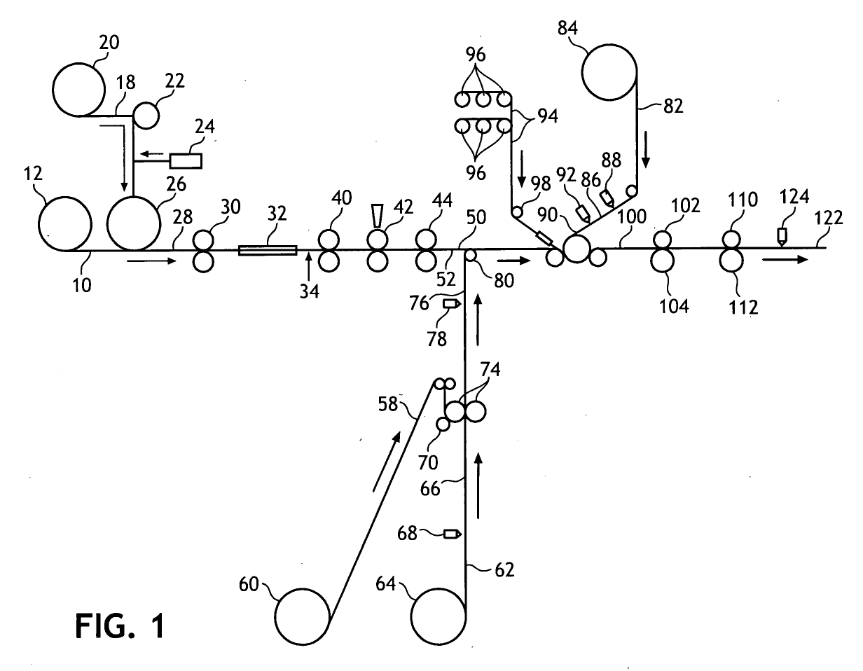

Referring to FIGS. 1-6, a method of forming an absorbent core is shown. The absorbent core can be used by itself as an absorbent pad to absorb human body fluids, such as urine, as well as semi-solid or solid excrement. Alternatively, the absorbent core can be assembled into an undergarment, brief, etc., such as an infant diaper, a menstrual panty, a child's training pant or an adult incontinent undergarment. The absorbent core is particularly designed for forming the crotch region of a three-piece, disposable absorbent undergarment. The absorbent core is a disposable item that is designed to be discarded after a single use.

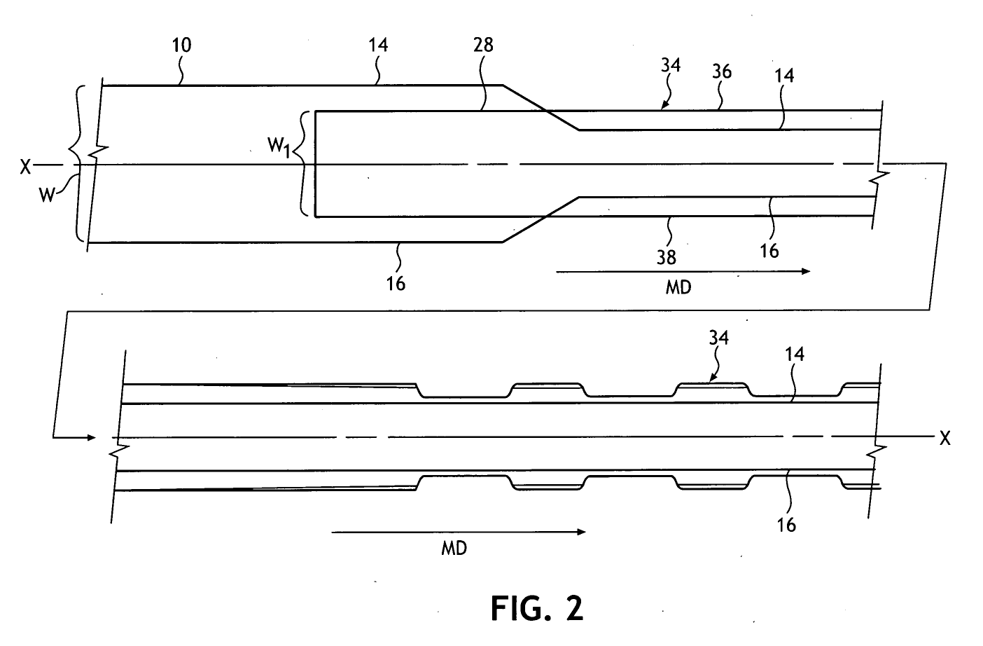

Turning to FIGS. 1 and 2, the method of forming an absorbent core starts with unwinding a carrier sheet 10 from a supply roll 12. The carrier sheet 10 has a pair of spaced apart side edges 14 and 16 and a width (w), see FIG. 2. The carrier sheet 10 can be constructed from any natural or synthetic material. Desirably, the carrier sheet 10 should be formed from an inexpensive material that is capable of allowing air, as well as a liquid or fluid, to pass therethrough. For purposes of this invention, liquid and fluid will be used interchangeably. A material that works well as the carrier sheet 10 is tissue. Tissue can be formed from one or more kinds of cellulose fibers.

Referring again to FIG. 1, the method further includes unwinding a cellulose pulp sheet 18 from a supply roll 20. The cellulose pulp sheet 18 can be formed from cross-linked pulps, hardwood, softwood, synthetic fibers or any combination thereof. The cellulose pulp sheet 18 is directed to a fiberizer 22 where the cellulose pulp sheet 18 is broken apart into individual fibers. The fiberizer 22 can consist of a hammer mill or other similar equipment which is capable of breaking or beating the cellulose pulp sheet 18 into individual fibers. The individual fibers are then mixed with air or pressurized air and acquire a fluffy appearance. Those skilled in the art normally referred to such fibers as “fluff”.

After exiting the fiberizer 22, one or more streams of superabsorbent material 24 are injected into the fluff. The superabsorbent material (SAM) 24 can be a hydrocolloidal material that functions to increase the amount of body fluid that can be absorbed and retained in the absorbent core. Normally, a superabsorbent is a material that is capable of absorbing at least 10 grams of water per gram of superabsorbent material. The superabsorbent material 24 can be in the form of small particles, fibers, flakes or other forms. Two suitable superabsorbents 24 for use in the absorbent core are BASF Hysorb 8800 AD and SXM 9394. The BASF Hysorb 8800 AD superabsorbent is commercially available from BASF Corporation, having an office at 11501 Steele Creek Road, Charlotte, N.C. 28273. The FAVOR SXM 9394 superabsorbent is commercially available from Stockhausen, Inc., a subsidiary of Stockhausen, GmbH having an office at 2401 Doyle Street, Greensboro, N.C. 27406. Other similar types of superabsorbents can also be used. The percentage of superabsorbent material 24 in the absorbent fluff/SAM mixture can vary from 1% to about 95%. Desirably, the percentage of superabsorbent material 24 in the absorbent fluff/SAM mixture can vary from about 10% to about 80%. More desirably, the percentage of superabsorbent material 24 in the absorbent fluff/SAM mixture can vary from about 25% to about 65%. The superabsorbent material 24 can be dispersed throughout the fibrous structure. Alternatively, the superabsorbent material 24 can be dispersed into one or more pre-selected areas or regions of the absorbent fluff. The exact positioning of the superabsorbent material 24 in the absorbent fluff will be dependent on the type of absorbent core being produced, the size and shape of the absorbent core, as well as the gender of the wearer of the absorbent core.

The mixture of superabsorbent 24 and fluff (fiberized pulp) is then deposited onto the surface of a forming drum 26. The peripheral surface of the forming drum 26 is constructed from a fine mesh screen that allows air to pass through while gathering the fluff/SAM mixture to a predetermined thickness. This fluff/SAM mixture forms into a continuous web 28 which is deposited onto the upper surface of the carrier sheet 10. The fluff/SAM mixture has a width (w₁).

Turning now to FIG. 2, one can see that the carrier sheet 10 has a longitudinal axis X—X and is being advanced from left to right. This left to right direction is the machine direction (MD) of the carrier sheet 10. The machine direction (MD) is aligned parallel to the longitudinal axis X—X of the carrier sheet 10. One will also notice that the width (w) of the carrier sheet 10 is wider than the width (w₁) of the fluff/SAM web 28. This size difference will allow the carrier sheet 10 to be at least partially wrapped or folded around the fluff/SAM web 28, as will be explained shortly. However, if one desired, one could make the width (w) of the carrier sheet 10 equal to the width (w₁) of the fluff/SAM web 28 but then the carrier sheet 10 could not be wrapped or folded around the fluff/SAM web 28.

Referring again to FIGS. 1 and 2, the fluff/SAM web 28, residing on the upper surface of the carrier sheet 10, is shown being passed between a pair of nip rolls 30 wherein it is debulked or reduced in thickness. This debulking step is optional and may be eliminated or be used later downstream, depending on one's preferences. The carrier sheet 10 is then wrapped or folded around at least a portion of the fluff/SAM web 28 by a folding mechanism 32. The folding mechanism 32 longitudinally wraps or folds the carrier sheet 10 around at least a portion of the advancing fluff/SAM web 28 in a direction aligned parallel to the longitudinal axis X—X (the machine direction). This wrapping or folding operation creates an absorbent strip 34 having a pair of spaced apart side edges 36 and 38, see FIG. 2. As best seen in FIG. 2, the carrier sheet 10 is C-folded in the longitudinal direction around the fluff/SAM web 28 such that its longitudinal edges 14 and 16 are spaced apart from one another. Alternatively, the longitudinal edges 14 and 16 of the carrier sheet 10 could abut or overlap one another, if desired. It should be noted that the absorbent core is being assembled upside down and by C-folding the carrier sheet 10 as indicated, one will increase the opportunity for body fluid to quickly contact the fluff/SAM web 28 and be absorbed and retained. The reason for this is that the body fluid does not have to pass thru the carrier sheet 10.

Returning to FIG. 1, the absorbent strip 34 is then passed between a pair of nip rolls 40 and is debulked or reduced in thickness. As stated above, only one pair of nip rolls 30 or 40 may be required and therefore the fluff/SAM web 28 could be debulked either before or after the wrapping step. Alternatively, as is shown in FIG. 1, both pairs of nip rolls 30 and 40 can be utilized. The debulking operation can reduce the thickness of the absorbent strip 34 from between about 10% to about 95%. Desirably, the debulking operation can reduce the thickness of the absorbent strip 34 from between about 20% to about 90%. Most desirably, the debulking operation can reduce the thickness of the absorbent strip 34 from between about 30% to about 85%.

After being debulked, the absorbent strip 34 is longitudinally trimmed by a cutter 42 into a preconceived shape. The trimming step removes material from locations on the absorbent strip 34 that will eventually become the crotch region of the absorbent core. As best seen in FIG. 2, a portion of the pair of side edges 36 and 38 of the absorbent strip 34, consisting of both the carrier sheet 10 and the fluff/SAM web 28, is cut away to produce a stepped or undulating profile. This stepped or undulating profile extends along the length of the absorbent strip 34. One will notice that the longitudinal trimming of the absorbent strip 34 removes less than about 50% of the material forming the width (w₁) of the absorbent strip 34. Desirably, the trimming removes less than about 40% of the material forming the width (w₁) of the absorbent strip 34. More desirably, the trimming removes less than about 30% of the material forming the width (w₁) of the absorbent strip 34. Most desirably, the trimming removes less than about 25% of the material forming the width (w₁) of the absorbent strip 34.

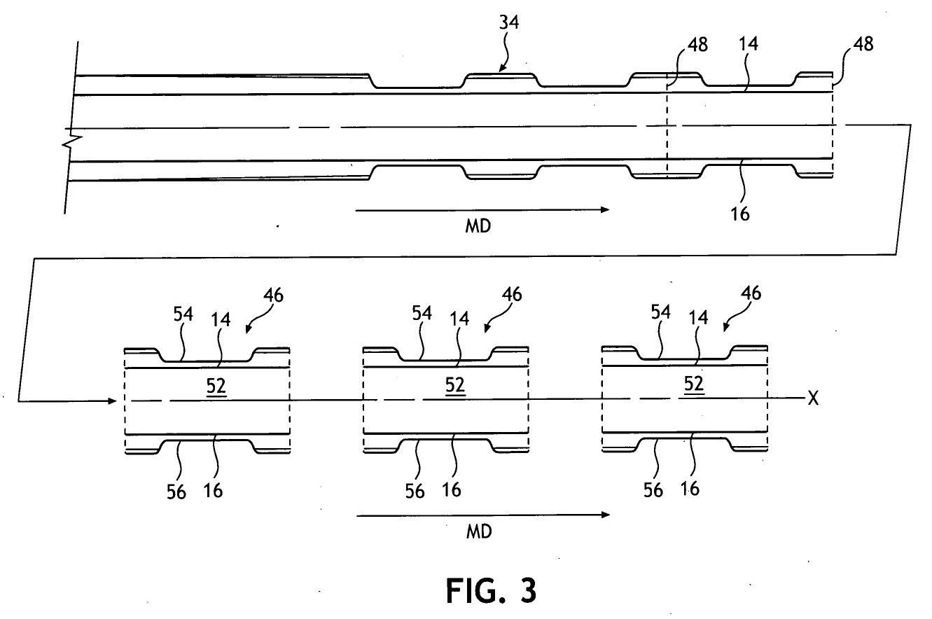

Referring now to FIGS. 1 and 3, the method further includes cutting or severing the absorbent strip 34 by a cutting mechanism 44 (see FIG. 1) into a plurality of individual absorbent members 46, see FIG. 3. The cutting mechanism 44 will sever the absorbent strip 34 in a transverse or cross-direction (CD), which is aligned approximately perpendicular to the machine direction (MD). As best seen in FIG. 3, a cut line 48 is formed which extends completely through the widest width section of the absorbent strip 34. It should be pointed out that the cut line 48 could be formed at any desired location along the length of the absorbent strip 34, depending upon the finished length of the absorbent core one desires. Once the individual absorbent members 46 are produced, they are longitudinally separated from one another. The exact distance of separation will depend upon the final design of the absorbent core, the running speed of the equipment, etc. The separation can easily be accomplished a variety of ways as is known to those skilled in the machinery art. One way is to use a pair of conveyor belts where a first conveyor supports the absorbent strip 34 and a second conveyor supports the individual absorbent members 46. By speeding up the second conveyor, slowing down the first conveyor, or a combination of speeding up one conveyor and slowing down the other conveyor, one can cause the individual absorbent members 46 to become longitudinally separated, in the machine direction (MD), a predetermined distance from one another.

Returning to FIG. 3, each of the individual absorbent members 46 has an upper surface 50, a lower surface 52, and a pair of non-linear side edges 54 and 56. More will be said about these upper and lower surfaces, 50 and 52 respectively, and the pair of non-linear side edges 54 and 56 shortly.

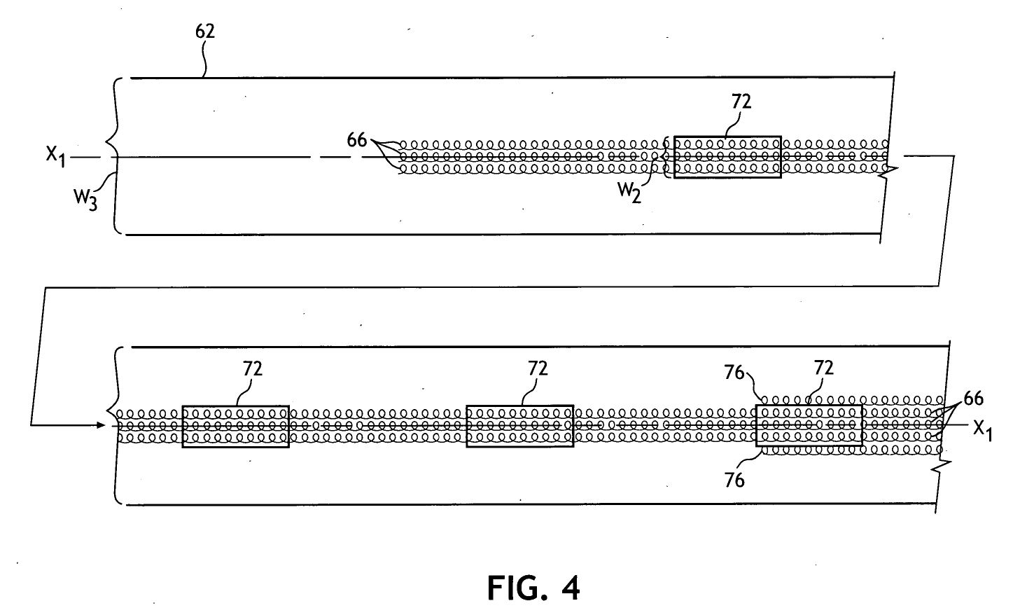

Referring now to FIGS. 1 and 4, the method also includes unwinding a surge material 58 from a supply roll 60. The surge material 58 can be any material that possesses the ability to transport liquid or fluid downward in the Z-direction so that the liquid or fluid can be transferred to an adjacent absorbent layer or into a superabsorbent material. The surge material 58 should also be able to wick liquid or fluid in the X and/or Y directions so as to disperse the liquid or fluid over a greater surface area of the adjacent absorbent layer. Sometimes the surge material is referred to as a fluid transfer layer or an acquisition/distribution layer. Whatever the name, they all function to transfer body fluid downward towards and into an adjacent absorbent layer. The surge material 58 can be formed from an airlaid material. Airlaid materials are commercially available from several manufacturers. Concert GmbH is one such supplier of airlaid material that can be used as the surge layer. Concert GmbH has an office located at Am Lehmberg 10, 16928 Falkenhagen, Germany.

Still referring to FIGS. 1 and 4, the method also includes unwinding a bodyside liner 62 from a supply roll 64. The bodyside liner 62 should be formed from a material that is liquid permeable, that is to say, it will allow liquid or fluid that contacts its upper surface to rapidly pass therethrough. Alternatively, the bodyside liner 62 can be treated with a surfactant to make it hydrophilic. By “hydrophilic” it is meant that the bodyside liner 62 will have a strong affinity for water and have a contact angle of less than 180 degrees. When the bodyside liner 62 is formed from a hydrophilic material, it will allow body fluid to pass quickly therethrough. Since the bodyside liner 62 is designed to contact the wearer's body, it should also be soft and pliable so as not to irritate the skin of the wearer of the absorbent core.

The bodyside liner 62 can be formed from a woven or non-woven material that is easily penetrated by body fluid, especially urine. The bodyside liner 62 can be constructed from natural or synthetic fibers. Suitable materials include bonded-carded webs of polyester, polypropylene, polyethylene, nylon or other heat-bondable fibers. Nonwovens are man made materials that work very well as bodyside liners. Suitable nonwoven materials include meltblown and spunbond webs. Spunbond works particularly well as a bodyside liner 62 and is manufactured and sold by Kimberly-Clark Corporation, having an office at 401 North Lake Street, Neenah, Wis. 54956.

In FIGS. 1 and 4, the surge material 58 is shown having a width w₂ and the bodyside liner 62 has a width w₃. The width w₃ of the continuous web of bodyside liner 62 is wider than the width w₂ of the surge material 58. A first construction adhesive 66 is applied onto a surface of the bodyside liner 62 by an adhesive gun 68, see FIG. 1. It should be noted that the adhesive 66 can be applied by spraying, coating, slot coating, brushing, painting, dipping the bodyside liner 62 in a bath of adhesive, etc. Such alternative ways of applying, spraying or coating a certain area of the bodyside liner 62 with an adhesive are well known to those skilled in the adhesive art.

The first adhesive 66 can be applied in any desired pattern or design. In FIG. 4, the first adhesive 66 is shown as three swirl lines aligned parallel to one another. The width of the three swirl lines of adhesive 66 corresponds approximately with the width w₂ of the surge material 58. At approximately the same time as the first adhesive 66 is being applied to the bodyside liner 62, or at a different time, the surge material 58 can be cut. Desirably, the surge material 58 is severed or cut approximately transversely or in a cross-direction (CD) which is aligned approximately perpendicular to the machine direction (MD). The surge material 58 is cut or severed by a cutter 70, see FIG. 1, into individual surge members 72. The length of each surge member 72 can vary depending upon the length and amount of surge material 58 needed for an intended absorbent core. Each surge member 72 is then separated or spaced apart from its adjacent trailing surge member 72 and is positioned and secured to the adhesively coated surface 66 of the continuous web of the bodyside liner 62 by a placement mechanism 74, see FIG. 1. The placement mechanism 74 spaces, positions and secures each of the plurality of surge members 72 onto the continuous web of the bodyside liner 62. The diameter and rotational speed of the placement mechanism 74 can be sized and adjusted, respectively, to accommodate the desired spacing. Once the individual surge members 72 are secured to the web of bodyside liner 62, both members will share a common longitudinal axis X₁—X₁, see FIG. 4.

Still referring to FIGS. 1 and 4, a second construction adhesive 76 is applied to the same surface of the bodyside liner 62, which was initially coated by the first adhesive 66, using an adhesive gun 78, see FIG. 1. It should be noted that the second adhesive 76 can be applied by spraying, coating, slot coating, brushing, painting, etc.

The second adhesive 76 is shown as being two, spaced apart swirl lines with each being aligned outboard of an edge of the three swirl lines of the first adhesive 66. Each of the two lines of the second adhesive 76 is aligned approximately parallel to the three swirl lines of the first adhesive 66. Again, it should be noted that the second adhesive 76 can be applied onto the bodyside liner 62 in any desired pattern or design. The second adhesive 76 will be used to bond the continuous bodyside liner 62 to a continuous outer cover.

In FIG. 4, one will notice that the three adhesive lines 66 and the two adhesive lines 76 are arranged along and aligned approximately parallel to the longitudinal axis X₁—X₁. In most applications, it is beneficial to position the surge member 72 in the center of the absorbent core. However, the first adhesive 66 and the individual surge members 72 could be offset from the longitudinal central axis X₁—X₁, if desired.

Referring to FIGS. 1, 3 and 4, the individual surge members 72, see FIG. 4, which have been joined to one of the surfaces of the continuous web of the bodyside liner 62, are advanced and aligned against the lower surface 52 of each of the spaced apart absorbent members 46, see FIG. 3. A roller 80 is used to assist in aligning the members 46, 72 and 62 together. Each of the individual surge members 72 is vertically aligned under an absorbent member 46. No adhesive is present between each vertically arranged surge member 72 and absorbent member 46. The reason for this is to allow body fluid which will insult the absorbent core to be quickly and efficiently transferred from the surge member 72 to the absorbent member 46. However, one could apply one or more spots or lines of adhesive between these two members, 46 and 62, if desired.

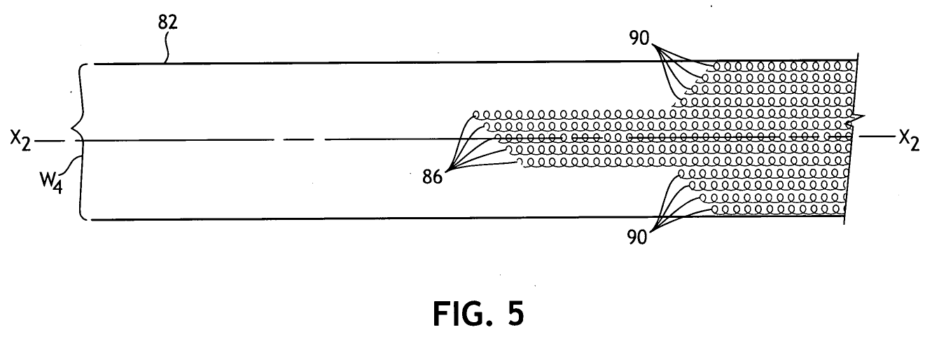

Referring now to FIGS. 1 and 5, the method also includes unwinding a continuous web of an outer cover 82 from a supply roll 84. The outer cover 82 should be formed from a material that is liquid-impermeable, that is to say, it will limit or prevent the passage of a liquid or fluid therethrough. The outer cover 82 can be soft and pliable, but, since it is not intended to contact the wearer's body, these features are not critical. However, it is desirable that the outer cover 82 be formed from a stretchable or elastic material so that it can extend and retract in one or more directions to accommodate the movement of the human torso. The outer cover 82 can be formed from an elastic material, an elastic composite or from a material having elastic properties. Stretch bonded laminates (SBL) and breathable stretch bonded thermal laminates (BSTL) are two materials that are very good to use in constructing the outer cover 82. Such laminates are commercially available from Kimberly-Clark Corporation, having an office at 401 North Lake Street, Neenah, Wis. 54956.

In FIG. 5, the outer cover 82 is shown having a width W₄ and a longitudinal axis X₂—X₂. The outer cover 82 can be formed from a variety of materials that exhibit the ability to limit and/or prevent a liquid or fluid from passing easily therethrough. For example, the outer cover 82 can be constructed from a thermoplastic film or a polymeric film formed from polyethylene or polypropylene or a combination thereof. The film can have a thickness in the range of from between about 0.1 millimeter (mm) to about 1.0 mm. Other liquid-impermeable materials can also be used to form the outer cover 82.

Still referring to FIGS. 1 and 5, a third construction adhesive 86 is applied onto a surface of the outer cover 82 by an adhesive gun 88. It should be noted that the third adhesive 86 can be applied by spraying, coating, slot coating, brushing, painting, dipping the outer cover 82 in a bath of adhesive, etc. Such alternative ways of applying, spraying or coating a certain area of the outer cover 82 with an adhesive are well known to those skilled in the adhesive art.

The third adhesive 86 can be applied in any desired pattern or design. In FIG. 5, the third adhesive 86 is shown as being applied as a plurality of swirl lines aligned parallel and adjacent to one another. The swirl lines are also depicted as being aligned with the longitudinal axis X₂—X₂ of the outer cover 82. The width of the several swirl lines of adhesive 86 corresponds approximately with about 75% of the width w₁, of the absorbent strip 34.

A fourth construction adhesive 90 is applied onto the same surface of the outer cover 82, which was initially coated by the third adhesive 86, using an adhesive gun 92. It should be noted that the fourth adhesive 90 can be applied by spraying, coating, slot coating, brushing, painting, dipping the outer cover 82 in a bath of adhesive, etc. The fourth adhesive 90 is shown as being several swirl lines that are spaced apart from one another and are aligned outboard or to the sides of the swirl lines of the third adhesive 86. Each of the swirl lines of the fourth adhesive 90 is aligned approximately parallel to the swirl lines of the third adhesive 86. Again, it should be noted that the fourth adhesive 90 can be applied onto the outer cover 82 in any desired pattern or design.

In FIG. 5, one will notice that the several swirl lines of adhesive 86 and 90 are arranged along and are aligned approximately parallel to the longitudinal axis X₂—X₂. In most applications, registration of an adhesive pattern along the longitudinal central axis of a web of material is common. However, the third and fourth swirl lines of adhesives, 86 and 90 respectively, can be offset from the longitudinal central axis X₂—X₂, if desired.

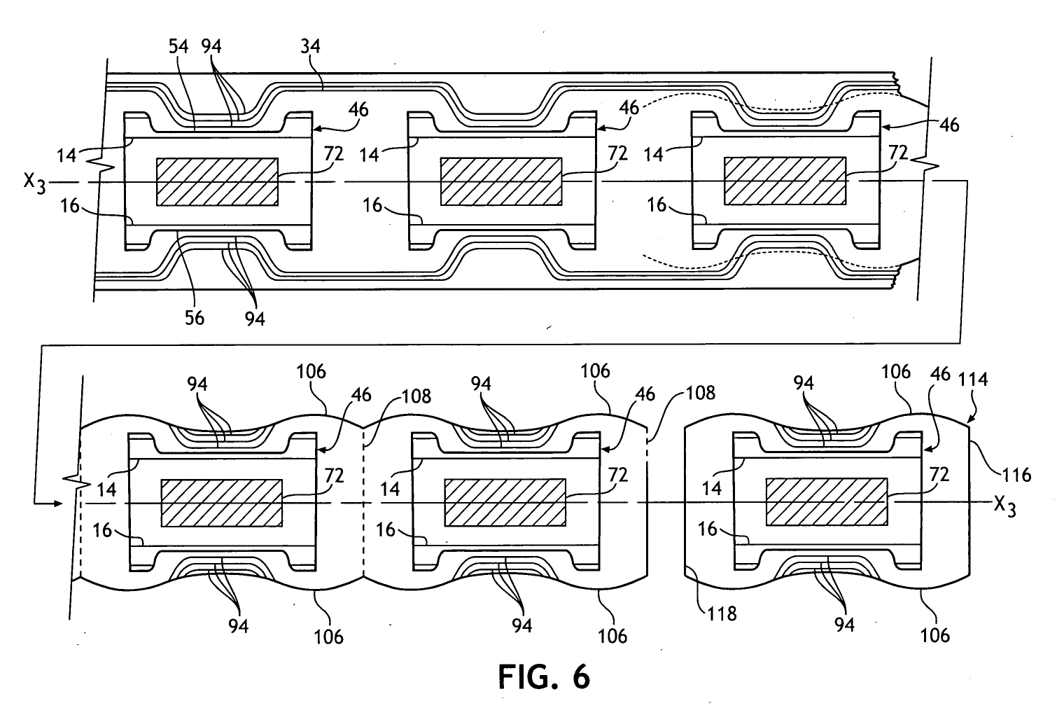

Referring now to FIGS. 1 and 6, a plurality of continuous elastic members 94 are unwound from supply rolls 96 and are directed towards a control mechanism 98. In FIG. 1, six supply rolls 96 are depicted from which six continuous elastic members 94 are unwound. However, any number of supply rolls 96 can be utilized depending on how many elastic members 94 are needed in the absorbent core. The elastic members 94 can be in the form of elongated elastic strands, strips, bands, tapes, etc., and can have various cross-sectional configurations. The elastic members 94 can be formed from rubber, polyurethane or other elastomeric materials. A suitable material from which the elastic members 94 can be formed is LYCRA. LYCRA is a registered trademark of E.I. DuPont De Nemours and Company, having an office in Wilmington, Delaware. LYCRA is commercially available from E.I. DuPont De Nemours and Company. SPANDEX is another elastic material that can also be used. SPANDEX is also a registered trademark of E.I. DuPont De Nemours and Company.

The control mechanism 98 will arrange and align the continuous elastic members 94 onto an upper surface of the continuous web of the bodyside liner 62. The control mechanism 98 will place the continuous elastic members 94 in any desired pattern onto the upper surface of the bodyside liner 62. In FIG. 6, three elastic members 94 are laid down adjacent to each of the side edges 54 and 56 of the absorbent member 46. Each of the three elastic members 94 can be evenly or non-evenly spaced apart from one another. When the elastic members 94 are arranged in a curved profile, their spacing normally gets closer to one another going into and coming out of a curve. However, the elastic members 94 can be evenly spaced apart even through a curve using specialized equipment known to those skilled in the art of manufacturing disposable absorbent products.

In FIG. 6, the pair of three elastic members 94 is shown being arranged on the upper surface of the bodyside liner 62 in an undulating or non-linear pattern. However, the pair of three elastic members 94 can be applied in a linear fashion, if desired. As best indicated in FIG. 6, the elastic members 94 are located outboard of the pair of side edges 54 and 56 of each of the absorbent members 46 and are arranged in a profile that follows the general shape of the side edges 54 and 56.

Still referring to FIGS. 1 and 6, the method further includes positioning the continuous outer cover 82 over the elastic members 94 and over the upper surface 50 of each of the absorbent members 46. The outer cover 82 is then joined to the continuous bodyside liner 62 by the adhesive 76 to form an absorbent core web 100. The absorbent core web 100 is then longitudinally trimmed in the machine direction which is aligned parallel to the longitudinal axis X₃—X₃. Desirably, the absorbent core web 100 is continuously trimmed for it is easier to remove a continuous trim piece than a plurality of non-continuous trim pieces. Experience has also shown that when the cutting blades or knives of a trim mechanism start to become dull, trim pieces have a tendency to tag and/or stick to the assembled product and can get carried along into the finished package. This is an undesirable feature.

The trimming is accomplished by passing the absorbent core web 100 between a rotating cutter roll 102 and a cooperating anvil roll 104, see FIG. 1. It should be noted that the trimming can be accomplished by using a knife, an arcuate knife, a flex knife or any other cutting device known to those skilled in the cutting art. The cutter roll 102 produces repeating hourglass or dumbbell-like longitudinal edges 106, see FIG. 6, by removing a portion of the bodyside liner 62, a portion of the outer cover 82 and a portion of the elastic members 94. It should be noted that the absorbent core web 100 could be trimmed into any desired shape.

A perforation line 108 is then cut or formed across the width of the absorbent core web 100 by a cutter roll 110 cooperating with an anvil roll 112, see FIG. 1. Other cutting mechanisms, such as a flex knife, a reciprocating chopper, etc., can also be used to form the perforation line 108. The perforation line 108 is desirably formed transversely across the entire width of the trimmed absorbent core web 100. The perforation line 108 will extend between the longitudinal edges 106. The perforation line 108 will be repeatedly formed at spaced apart intervals depending on the desired length one wishes to make the absorbent cores. In other words, the perforation lines 108 will be formed at what will eventually become the leading and trailing ends of each absorbent core. The perforation lines 108 are then broken to form individual absorbent cores 114, each having a leading end 116 and a trailing end 118, see FIG. 6.

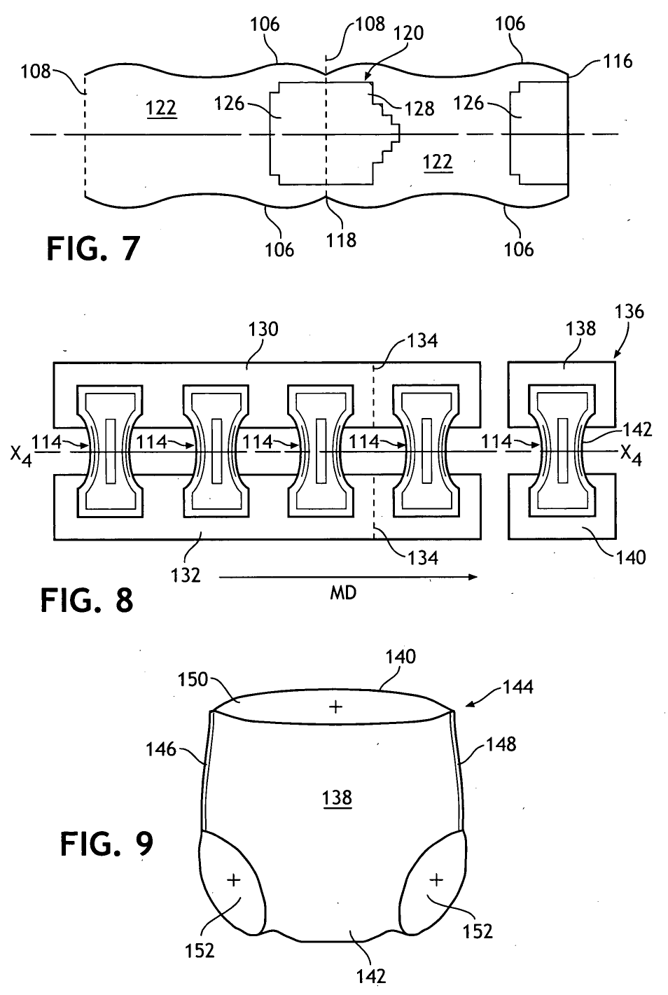

Referring now to FIGS. 1, 6 and 7, a construction adhesive 120 is applied onto a top surface 122 of the absorbent core web 100. It should be noted that the adhesive 120 can be applied by spraying, coating, slot coating, brushing, painting, etc. In FIG. 1, an adhesive gun 124 is used to spray adhesive onto the top surface 122 of the absorbent core web 100. As explained above, the absorbent cores are assembled upside down. In FIG. 7, the adhesive 120 is applied in a predetermined pattern having a first section 126 and a second section 128 separated by each of the perforation lines 108. The first section 126 is aligned adjacent to the leading end 116 of the absorbent core 114, see FIG. 6, and the second section 128 is aligned adjacent to the trailing end 118 of the absorbent core 114.

Turning now to FIG. 8, each absorbent core 114 can be secured at its leading and trailing ends, 116 and 118 respectively, to two, spaced apart continuous moving webs 130 and 132. Each of the two continuous webs 130 and 132 are spaced apart from one another a predetermined distance and both are advancing parallel along a longitudinal axis X₄—X₄. The longitudinal axis X₄—X₄is aligned parallel to a machine direction (MD). The machine direction (MD) is from left to right in FIG. 8. The absorbent core 114 is transversely aligned to each of the moving webs 130 and 132 and bridges across the two webs 130 and 132. The absorbent core 114 is secured to the two webs by the first and second sections of adhesive, 126 and 128 respectively. The two webs 130 and 132 are then cut or severed at predetermined locations by a transverse cut line 134. Once the webs 130 and 132 are cut, a three-piece disposable absorbent undergarment 136 is formed. The three-piece disposable absorbent undergarment 136 has a front region 138, a back region 140 and a crotch region 142. The absorbent core 114 forms the crotch region 142 of the disposable absorbent undergarment 136.

Referring now to FIG. 9, the three-piece disposable absorbent undergarment 136 is shown in the form of a unitary undergarment 144. The unitary undergarment is formed by folding the three-piece disposable absorbent undergarment 136 along the longitudinal axis (X₄—X₄. The front and back regions, 138 and 140 respectively, are then bonded together by side seams 146 and 148 to form the one-piece unitary undergarment 144. The side seams 146 and 148 can be formed using sonic energy, ultrasonic bonds, adhesive, stitching, etc. The unitary undergarment has a waist opening 150 and a pair of leg openings 152.

While the invention has been described in conjunction with several specific embodiments, it is to be understood that many alternatives, modifications and variations will be apparent to those skilled in the art in light of the aforegoing description. Accordingly, this invention is intended to embrace all such alternatives, modifications and variations that fall within the spirit and scope of the appended claims.

I claim:

1. A method of forming an absorbent core comprising the steps of:
a) forming an absorbent strip from a mixture of superabsorbent and fiberized pulp wrapped in a carrier sheet;
b) cutting said absorbent strip into a plurality of absorbent members and separating said absorbent members from one another, each of said absorbent members having an upper surface and a lower surface;
c) intermittently securing surge members onto a continuous bodyside liner and attaching both to said lower surface of each of said absorbent members, each of said surge members being vertically aligned under an absorbent member;
d) aligning elastic members on said continuous bodyside liner, said elastic members being located adjacent to each of said absorbent members;
e) positioning a continuous outer cover over said elastic members and said top surface of each of said absorbent members and then joining said continuous outer cover to said continuous bodyside liner to form an absorbent core web; and
f) severing said absorbent core web to form individual absorbent cores.

2. The method of claim 1 including the step of compressing said absorbent strip.

3. The method of claim 1 wherein said carrier sheet is tissue.

4. A method of forming an absorbent core comprising the steps of:
a) depositing a mixture of superabsorbent and fiberized pulp onto a carrier sheet;
b) wrapping said carrier sheet around at least a portion of said mixture to form an absorbent strip;
c) trimming said absorbent strip into a preconceived shape;
d) cutting said absorbent strip into a plurality of absorbent members and separating said absorbent members from one another, each of said absorbent members having an upper surface and a lower surface;
e) intermittently securing surge members onto a continuous bodyside liner and attaching both to said lower surface of each of said absorbent members, each of said surge members being vertically aligned under an absorbent member;
f) aligning elastic members on said continuous bodyside liner, said elastic members being located adjacent to each of said absorbent members;
g) positioning a continuous outer cover over said elastic members and said top surface of each of said absorbent members and then joining said continuous outer cover to said continuous bodyside liner to form an absorbent core web;
h) trimming said absorbent core web;
i) forming perforation lines transversely across said absorbent core web at spaced apart intervals; and
j) breaking said perforation lines to form individual absorbent cores.

5. The method of claim 4 including the step of compressing said mixture of superabsorbent and fiberized pulp after it has been deposited onto said carrier sheet.

6. The method of claim 4 including the step of compressing said absorbent strip.

7. The method of claim 4 wherein said tissue is C-folded around at least a portion of said mixture of superabsorbent and fiberized pulp.

8. The method of claim 4 wherein said absorbent strip is trimmed into said preconceived shape and said preconceived shape has a non-linear configuration.

9. The method of claim 4 wherein said absorbent core web is continuously trimmed in a longitudinal direction which is aligned parallel to the machine direction of said absorbent core web.

10. A method of forming an absorbent core comprising the steps of:
a) depositing a mixture of superabsorbent and fiberized pulp onto a carrier sheet;
b) wrapping said carrier sheet around at least a portion of said mixture to form an absorbent strip;
c) trimming said absorbent strip into a preconceived shape;
d) cutting said absorbent strip into a plurality of absorbent members and separating said absorbent members from one another, each of said absorbent members having an upper surface, a lower surface and a pair of side edges;
e) securing spaced apart surge members onto a continuous bodyside liner and attaching said surge members and said continuous bodyside liner to said lower surface of each of said absorbent members, each of said surge members being vertically aligned under an absorbent member;
f) aligning elastic members on said continuous bodyside liner, said elastic members being located outboard of said pair of side edges of each of said absorbent members;
g) positioning a continuous outer cover over said elastic members and said top surface of each of said absorbent members and then joining said continuous outer cover to said continuous bodyside liner to form an absorbent core web;
h) trimming said absorbent core web;
i) forming perforation lines transversely across said absorbent core web at spaced apart intervals; and
j) breaking said perforation lines to form individual absorbent cores.

11. The method of claim 10 wherein said absorbent core web is continuously trimmed, and during trimming said continuous bodyside liner, said continuous outer cover and a portion of said elastic members are cut.

12. The method of claim 11 wherein said continuous bodyside liner, said continuous outer cover and a portion of said elastic members are cut using an arcuate shaped knife.

13. The method of claim 10 wherein said spaced apart surge members are adhesively secured to said continuous bodyside liner.

14. The method of claim 10 including applying a first adhesive onto a surface of said continuous outer cover and applying a second adhesive outboard of said first adhesive, said second adhesive being used to secure said elastic members between said continuous bodyside liner and said continuous outer cover.

15. The method of claim 10 further including the step of securing said individual absorbent cores across two spaced apart moving webs and cutting said two webs at predetermined locations to form a three-piece disposable undergarment.

16. A method of forming an absorbent core for a three-piece, disposable absorbent undergarment comprising the steps of:
a) depositing a mixture of superabsorbent and fiberized pulp onto a carrier sheet;
b) wrapping said carrier sheet around at least a portion of said mixture to form an absorbent strip;
c) trimming said absorbent strip into a preconceived shape;
d) cutting said absorbent strip into a plurality of absorbent members and separating said absorbent members from one another, each of said absorbent members having an upper surface, a lower surface and a pair of side edges;
e) securing spaced apart surge members onto a continuous bodyside liner and attaching said surge members and said continuous bodyside liner to said lower surface of each of said absorbent members, each of said surge members being vertically aligned under an absorbent member;
f) aligning elastic members on said continuous bodyside liner, said elastic members being located outboard of said pair of side edges of each of said absorbent members;
g) positioning a continuous outer cover over said elastic members and said top surface of each of said absorbent members and then joining said continuous outer cover to said continuous bodyside liner to form an absorbent core web;
h) trimming said absorbent core web;
i) forming perforation lines transversely across said absorbent core web at spaced apart intervals;
j) breaking said perforation lines to form individual absorbent cores; and
k) securing said individual absorbent cores across two spaced apart moving webs and cutting said two webs at predetermined locations to form three-piece disposable absorbent undergarments.

17. The method of claim 16 wherein each of said individual absorbent cores has a first end and a second end and adhesive is applied adjacent to said first and second ends for securing each of said absorbent inserts to said two, spaced apart moving webs.

18. The method of claim 17 wherein each of said absorbent cores is transversely positioned across said two spaced apart moving webs.

19. The method of claim 16 wherein during trimming of said absorbent core web, said continuous bodyside liner, said continuous outer cover and a portion of said elastic members are cut.

20. The method of claim 16 wherein said continuous bodyside liner, said continuous outer cover and a portion of said elastic members are cut using an arcuate shaped knife.
